(19) United States
(12) Patent Application Publication
(10) Pub. No.: US 2025/0145853 A1
(43) Pub. Date: May 8, 2025

(54) PROTECTION COATING COMPOSITION, TREATING METHOD USING THE SAME AND ARTICLE THEREOF

(71) Applicant: Henkel AG & Co. KGaA, Düsseldorf (DE)

(72) Inventors: XiaoMeng Wu, Shanghai (CN); Yakun Zhu, Shanghai (CN); XiLin Zhang, Shanghai (CN); Yi Zhang, Shanghai (CN)

(21) Appl. No.: 19/016,251

(22) Filed: Jan. 10, 2025

Related U.S. Application Data
(63) Continuation of application No. PCT/CN2022/105720, filed on Jul. 14, 2022.

(51) Int. Cl. C09D 175/14; C09D 5/08; C09D 7/61; C09D 7/63; C09D 175/04

(52) U.S. Cl. CPC C09D 175/14; C09D 5/084; C09D 5/086; C09D 7/61; C09D 7/63; C09D 175/04

(57) ABSTRACT

This invention relates to a protection coating composition, which comprises a) at least one resin, the resin being selected from a group consisting of polyurethane resin (A), polyurethane-acrylic resin(B), b) a solvent, c) a bi-functional epoxy resin precursor (C), the bi-functional epoxy resin precursor (C) being represented by the following formulas: R₁—Y—[CH₂—CH(OH)—R₃—CH(OH)—CH₂—X—R₄—X]ₙ—R₂. This invention also provides a method for treating metallic surface by using the protection coating composition, an article which has at least one portion that comprises side treated surface by the protection coating composition, which demonstrates improved corrosion resistance, adhesion properties and anti-aging adhesion properties.

### TECHNICAL FIELD

This invention relates to a protection coating composition and a method for treating metallic substrate surfaces that are coated with zinc or zinc alloys or with aluminum or aluminum alloys by the protection coating composition. It is particularly suitable for the surface treatment in coil coating for the application of these substrates in household and architectural segments as well as in the automobile industry. An article comprising such metallic substrate surfaces treated by the protection coating composition demonstrates improved adhesion and good corrosion resistance property.

### BACKGROUND OF THE INVENTION

Among the practically used metal materials, light metal materials such as aluminium and magnesium materials are the lightest ones and also have high specific strength and therefore, they have been applied in various fields such as interior and exterior parts for motor cars and two-wheeled vehicles, parts for household appliances, containers for storage such as bags and suitcases, goods for sports, parts for optical machinery and tools, sticks and further new fields in electronic industries such as computers and acoustics. However, the light metal materials are the most active metal materials and accordingly, it has been difficult to use them per se without any treatment because of their low corrosion resistance.

In household and architectural segments as well as in the automobile industry, the demand for sheet metal with a pre-applied coating is growing, which, for example, facilitates mechanical processing such as stamping, drilling, folding, profiling and/or deep drawing. This pre-applied coating must impart to the sheet metal properties which not only inhibit corrosion but also facilitate mechanical processing. A further function of such pre-applied coatings is to provide a base for subsequent decorative topcoat layers. A workpiece produced by mechanical processing from a sheet metal material pre-coated in this manner may then finally be provided with a topcoat.

According to the prior art, the coil coating method substantially consists of three sub-steps. In a first step, the sheet metal is cleaned and provided with an inorganic pretreatment layer, in the second step the primer is applied, and in the final third method step the topcoat is applied. In some applications, clear coats/varnish or protective film coverings may additionally be applied. Attempts have been made to provide just with the pretreatment step those functions which facilitate use in the manner of the above-stated pre-applied coating. For example, a suitable organic polymer is added to the inorganic conversion treatment for this purpose, which polymer is capable of forming a surface film exhibiting the functional properties required of a pre-applied coating.

DE19923118A1 discloses a polymerizable composition for the organic coating of metallic substrates and a method for protecting a steel substrate by a thin film of an organic/inorganic hybrid polymer based on an alkoxysilane, a further condensable organometallic compound of the formula M(OR)₄ and (meth)acrylic acid, water and a polymerization initiator. Coating is cured by thermal or photopolymerization. Zirconium and titanium are mentioned as metals for the organometallic compound. It is stated that such a film protects steel substrates from corrosion and oxidation and this coating is moreover intended to protect the substrate from impact and other mechanical effects.

DE19751153A discloses polymerizable compositions containing titanium, manganese and/or zirconium salts of olefinically unsaturated, polymerizable carboxylic acids and other olefinically unsaturated comonomers and a radical polymerization initiator are suitable for the organic coil coating of metallic materials. These non-aqueous metal coatings are suitable for the chromium-free pretreatment of steel with excellent corrosion control.

DE19754108A1 describes a chromium-free aqueous corrosion protection composition for the treatment of galvanized or alloy galvanized steel surfaces as well as aluminum surfaces. The agent is particularly suitable for treating metal strips in order to protect them against corrosion, with or without subsequent painting, and is preferably applied in such a way as to produce a dry layer coating on the surface.

Despite the wide-ranging prior art, a need still remains for improved anticorrosion agents and coating methods for metal surfaces which permit chromium-free pretreatment of the metallic substrates with good corrosion protection while avoiding strong acids, large amounts of organic solvent and elevated fluoride concentrations.

Accordingly, it is an object of the present invention to provide a surface protection coating composition for light metallic materials, especially aluminium, zinc or its alloy, which can eliminate the problems associated with the conventional surface treatment compositions.

### SUMMARY OF THE INVENTION

The present invention relates to a protection coating composition which is alkaline and could be organic solvent-free. The protection coating composition integrates the properties of pretreatment and primer, which shows good adhesion property, and further shows improved corrosion protection property. The protection coating composition can react with metallic substrate directly and form a very thin protection coating with a thickness of 0.5-4.0 microns, preferably 1.0-3.0 microns, preferably 1.0-2.0 microns. The protection coating, which is a cured product of the protection coating composition, provides good adhesion between the metallic substrate and top coating, thus the treated substrate can meet the T-bend (fresh) of equal to or less than 1 T without any further primer and fulfill the molding requirement. In addition, the treated substrate can meet the T-bend (aged) of equal to or less than 2 T after 24 hours of aging at a temperature of 50±2° C. and a humidity of 95%, when subjected to GB/T13448-2006. The substrate is preferably galvanized steel coils, the treated substrate is preferably used as color coated coil.

The coating composition according to present invention furthermore preferably acts as a two-in-one primary coating of pretreatment and primer, the topcoat layer then being applied immediately thereafter in the coil coating plant. In this case, only once it is fully coated, the sheet metallic material will be sent for further processing. Comparing to the traditional coil coating method, the primer coating step and thereafter baking step could be saved.

The present invention relates to a protection coating composition comprising:
at least one resin, the resin being selected from a group consisting of polyurethane resin (A), polyurethane-acrylic resin(B),
a solvent, and
a bi-functional epoxy resin precursor (C), the bi-functional epoxy resin precursor (C) being represented by the following formulas:

R₁—Y—[CH₂—CH(OH)—R₃—CH(OH)—CH₂—X—R₄—X]ₙ—R₂
wherein, independently,
X=—COO—, sulphur moiety, —NR(H)—, —P(OR)₂—O—, —P(OR)(OH)—O—, —PO—O—;
Y=—COO—, sulphur moiety, —NR(H)—, —P(OR)₂—O—, —P(OR)(OH)—O—, —PO—O—;
R₂ being aromatic chain or aliphatic chain having from 1 to 20 carbon atoms or H;
R₄ being aromatic chain or aliphatic chain having from 1 to 20 carbon atoms;
R₁ being aromatic chain or aliphatic chain having from 1 to 20 carbon atoms, —XH or —X—R₄;
R₃ being any types of chain as far as it connects two hydroxyl α-carbon atoms;
n being an integer of 1˜10.

The present invention also relates to a method for treating a metallic surface by using the protection coating composition according to present invention, comprising steps of:
a) bringing the protection coating composition of present invention into contact with a metallic surface at a process temperature of at least 40° C., but no higher than 200° C., thereby creating a film on the metallic surface;
b) optionally removing excess quantities of the protection coating composition from the surface; and
c) curing the film located on the surface by means of thermal methods at a process temperature of 50° C. to 90° C., or high-energy irradiation for a period of at least 10-5 seconds to form a cured coating.

The present invention further relates to an article having at least one portion that comprises the treated metallic surface of present invention. The present invention also relates to an article having at least one portion that comprises a protection coating which is a cured product of the protection coating composition according to present invention. The protection coating exhibits a layer thickness of at least 0.5 μm, but of no more than 4.0 μm.

### DETAILED DESCRIPTION OF THE INVENTION

In the following passages the present invention is described in more detail. Each aspect so described may be combined with any other aspect or aspects unless clearly indicated to the contrary. In particularly, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

The terms aluminum or zinc is used herein includes both the pure metal and alloys are designated hereinafter simply as “aluminum” or “zinc”, unless the context requires otherwise.

The terms “mass” and “weight” are used synonymously herein. Thus “percent by weight” (% by weight) means the percentage by mass content, based on the mass (by weight) of the entire composition or on the basis of all molecules, unless otherwise stated.

A “primary coating” used herein means that the metallic substrate was not subjected to any other protection treatment prior to the contact with the protection coating composition according to present invention. In fact, the protection coating composition according to present invention should be applied onto a freshly produced or freshly cleaned dry metal surface. This treatment illustrates the primary or the sole protection measure for the metallic substrate. After the application of the protection composition according to the invention it is possible to superimpose additional decorative and/or corrosion protective coatings such as for example conventional dip paints, spray paints or powder paints. The primary coating of present invention applied a thin layer of protection coating on the metallic substrate as a two-in-one coating of pretreatment and primer.

Either a freshly produced or a freshly cleaned metal surface that has not been subjected to any protection measure is brought into contact with the protection coating composition according to the invention, and the protection coating composition is cured, and a protection coating is formed on a metal sheet surface. In this way a treated metal surface is obtained that has a protection primary coating.

The metal sheet can be stored and/or shipped in this form. In addition, it can be cut into pieces and optionally shaped and joined together with further pieces into structural units. Metal surfaces that have been coated with the protection coating composition according to the invention can also be commercialized and further processed without an additional coating being deposited onto the protection coating. Depending on the final end use, additional decorative coatings can be applied once the final metal object has been manufactured.

Alternatively, the metal sheet surface coated with the protection coating composition according to the invention or metal sheets cut out of it can be over coated with at least one additional decorative coating or corrosion protection coating such as for example with a top coating, before these metal sheets are commercialized and/or further processed into sub-assemblies. In this case the protection coating according to the invention functions as a combination of “pre-treatment” and “primer”. The protection coating also provides good adhesion between the following top decorative coating and the metal substrate, for color-coated sheet, such good adhesion property could meet the molding requirement in the latter operation. Thus, it can reduce some failure conditions such as paint film pulverization, foaming, breakage etc.

### Protection Coating Composition

The present invention relates to a protection coating composition comprises: a solvent, a bi-functional epoxy resin precursor (C), an optional polyacrylic-epoxy resin (D) and a resin selected from a group consisting of polyurethane resin (A), polyurethane-acrylic resin (B). In some embodiments, the protection coating composition is an aqueous dispersion.

### Polyurethane Resin (A)

The polyurethane resin (A) used in the present invention may be produced by subjecting an organic compound containing two or more hydroxyl groups in a molecule thereof (polyol) and a polyisocyanate to polyaddition reaction, further chain-extending with diamine or the like, and dispersing it in water or the like.

The polyol is not particularly limited as long as it contains two or more hydroxyl groups in a molecule thereof. As the polyol, preferred are a polycarbonate polyol, a polyester polyol. More specifically, the polyurethane resin (A) is preferably in the form of a polycarbonate-based polyurethane or a polyester-based polyurethane.

The polycarbonate polyol may be produced by reacting a carbonate compound with a diol. Examples of the carbonate compound include dimethyl carbonate, diethyl carbonate, diphenyl carbonate, ethylene carbonate, diethylene carbonate and the like. Examples of the diol include an aliphatic diol that may be substituted with a lower alcohol; an alicyclic diol such as cyclohexanediol, a hydrogenated xylene glycol, etc.; and an aromatic diol such as xylylene glycol, etc. Among these diols, preferred is an aliphatic diol, and more preferred is an aliphatic diol having a carbon chain length of not less than 4 and not more than 9, such as 1,4-butanediol, 3-methyl-1,5-pentanediol, 1,6-hexanediol, heptanediol, octanediol, nonanediol, etc.

The polyester polyol may be produced by subjecting a low-molecular diol and a dicarboxylic acid to condensation reaction. Examples of the low-molecular diol include diols having not less than 2 and not more than 6 carbon atoms, such as ethylene glycol, diethylene glycol, propylene glycol, dipropylene glycol, 1,4-butanediol, etc. Among these low-molecular diols, preferred are ethylene glycol, propylene glycol, 1,4-butanediol and the like. Examples of the dicarboxylic acid include aliphatic dibasic acids such as succinic acid, glutaric acid, adipic acid, pimelic acid, suberic acid, azelaic acid, sebacic acid, brassylic acid, etc.; and aromatic dibasic acids such as isophthalic acid, terephthalic acid, naphthalenedicarboxylic acid, etc. Among these dicarboxylic acids, preferred are aliphatic dibasic acids, and more preferred are dibasic acids having a methylene chain length of not less than 4 and not more than 8, such as adipic acid, pimelic acid, suberic acid, azelaic acid, sebacic acid, etc.

Examples of the polyisocyanate include a chain-like aliphatic diisocyanate such as tetramethylene diisocyanate, 1,6-hexamethylene diisocyanate, dodecamethylene diisocyanate, trimethyl hexamethylene diisocyanate, lysine diisocyanate, etc.; an aliphatic diisocyanate having a cyclic structure such as isophorone diisocyanate, a hydrogenated xylylene diisocyanate, dicyclohexylmethane 4,4′-diisocyanate, etc.; an aromatic ring-containing aliphatic diisocyanate such as xylylene diisocyanate, tetramethyl xylylene diisocyanate, etc.; an aromatic diisocyanate such as tolylene diisocyanate, diphenylmethane diisocyanate, etc.; and modified products of these diisocyanates (such as carbodiimide-, uretdione- and uretimine-containing modified products, etc.), and the like. Among these polyisocyanates, preferred are an aliphatic diisocyanate and an aromatic diisocyanate.

The polyurethane resin (A) is preferably used in the form of an aqueous dispersion thereof. The aqueous dispersion of the polyurethane resin (A) may also contain a dispersant such as a surfactant, if required.

In some embodiments, the polyurethane resin (A) is an aqueous anionic dispersion. In some embodiments, the polyurethane resin (A) preferably contains acid groups from the viewpoint of improving dispersion stability thereof in an aqueous medium as well as from the viewpoint of improving storage stability of the aqueous dispersion as well as adhesion properties and optical density of the aqueous dispersion. As the acid groups of the polyurethane resin (A), from the viewpoint of improving storage stability of the water-based pigment dispersion as well as adhesion properties and optical density of the water-based ink, preferred is a carboxyl group.

The carboxy group-containing polyurethane resin (A) may be produced by subjecting the polyol, the polyisocyanate and a dialkanol carboxylic acid to polyaddition reaction. Examples of the dialkanol carboxylic acid include dimethylol butanoic acid, dimethylol propionic acid and salts of these acids, and the like. Examples of the reaction solvent used in the aforementioned polyaddition reaction include acetone, methyl ethyl ketone, tetrahydrofuran, dioxane, ethyl acetate, toluene, xylene and the like. In the aforementioned polyaddition reaction, a chain extender or a reaction terminator may also be used in combination with the aforementioned components, if required. By using the chain extender, it is possible to increase a molecular weight of the resulting resin. As the chain extender, there may be a polyol and a polyamine. Also, as the reaction terminator, there may be a monoalcohol and a monoamine.

Most or even all of the polyurethane resins included in the protection coating composition preferably have carboxyl groups. The carboxyl groups, which are optionally neutralized and reacted, in particular by ammonia, amines (in particular alkanolamines) or/and alkali metal compounds, to form an aqueous solution with a polyurethane synthetic resin which can be dispersed easily with water, are optionally not water-soluble before the reaction under standard conditions. The neutralization of the —COOH groups is an anionic stabilization. It may additionally be necessary to additionally add at least one emulsifier or/and at least one protective colloid (as additives within the scope of the present application) to stabilize the dispersion of the polyurethane synthetic resin and the protection coating composition.

In the preparation process of the present invention, the pH of the aqueous coating composition without the addition of further compounds may preferably be from greater than 7 to 12, particularly preferably from greater than 7 to 11, from 7.5 to 10.5 or from 8 to 9.5. It should be noted that the polyurethane resin has typically been neutralized by the manufacturer, e.g., during polymerization. The aqueous coating composition preferably has a pH of 1 to 12 in an aqueous formulation without the addition of other compounds. If during the preparation of the aqueous composition the pH of the aqueous composition shifts to a value outside the range of greater than 7 to 11, it is advisable to bring it back to the pH range of greater than 7 to 11 or even to a narrower working range within this range by means of a suitable addition, but preferably only at least one basic substance is added, since undesirable salt formation may occur upon addition of acid or/and acidic substance. If the pH drops as a result of storage of the synthetic resin or/and mixture, it may be helpful to bring the pH (in particular the pH of the aqueous coating composition otherwise ready for use) back into the more alkaline range by adding, for example, aqueous sodium hydroxide solution.

In some embodiments of the present invention, the polyurethane resins have a glass transition temperature (Tg) of −100° C. to −50° C., or −100° C. to −70° C., and an elongation of 300% or more, or 500% or more.

In some embodiments of the present invention, the weight average molecular weight of the polyurethane resin may be at least 2,000, preferably 5,000-250,000, particularly preferably 20,000-200,000.

In some embodiments of the present invention, the content of the polyurethane resin in the protection coating composition is from 60 wt. % to 85% wt. %, or 65 wt. % to 80 wt. %, or 70 wt. % to 85 wt. %, based on the total weight of solid contents in the protection coating composition. The lower limit concentration of the polyurethane resin in the protection coating composition is 60 wt. %, 65 wt. %, or 70 wt. %. The upper limit concentration of the polyurethane resin is 85 wt. %, or 80 wt. %, or 75 wt. %.

As used herein, “Mw” refers to the weight average molecular weight and means the theoretical value as determined by Gel Permeation Chromatography (GPC) relative to linear polystyrene standards of 1.1 M to 580 Da and may be performed using Waters 2695 separation module with a Waters 2414 differential refractometer (RI detector).

In some embodiments, the polyurethane resin (A) is an aqueous anionic dispersion, and the polyurethane resins include polyether based polyurethane resins and polyester based polyurethane resins.

Examples of commercially available polyurethane resins are, for example, Leasys 3900 or Leasys 5531 from Wanhua Chemical, K200 polyurethane resin from Anhui Andahuatai materials.

The above polyurethane resin can be used alone or in any combinations.

In some embodiments, the polyurethane resin (A) is an aqueous anionic dispersion, and the polyurethane resins include polycarbonate based polyurethane resins.

Examples of commercially available polycarbonate resins are, for example, Hauthane L-3528 and L-3529 from Hauthaway, Esacote PU A32D and ESACOTE PU 6419 from Lamberti.

The above polyurethane resins can be used alone or in any combinations.

### Polyurethane-Acrylic Resin (B)

In some embodiments, the polyurethane-acrylic resin (B) is an aqueous dispersion of polyurethane-acrylic resin.

The polyurethane-acrylic resin can be directly synthesized according to a known method, or be commercially available. For example, the acrylic urethane dispersion can be prepared by reacting polyols, acids, isocyanates, and acrylates. The polyols may be one or more selected from the group comprising polybutylene glycol (PTMG), 1,6-hexanediol, ethylene glycol, propylene glycol, diethylene glycol, butylene glycol, neopentyl glycol, trimethylolpropane, butanediol, 1,4-hexanediol and 3-methylpentanediol. The acids may be one or more selected from the group comprising dimethylolpropionic acid (DMPA), acrylic acid, and adipic acid, phthalic acid, isophthalic acid, terephthalic acid, tetrahydrophthalic acid, hexahydrophthalic acid, adipic acid, fumaric acid, maleic acid, trimellitic acid, malic acid and aconitic acid. In addition, the isocyanates may be one or more of selected from the group comprising isophorone diisocyanate (IPDI), trimethylene diisocyanate, tetramethylene diisocyanate, pentamethylene diisocyanate, hexamethylene diisocyanate, propylene diisocyanate, ethylene diisocyanate, 2,3-dimethylethylene diisocyanate, 1-methyl trimethylene diisocyanate, 1,3-cyclopentene diisocyanate, 1,4-cyclopentene diisocyanate, 1,2-ring pentene diisocyanate, m-phenylene diisocyanate, p-phenylene diisocyanate, 2,4-toluene diisocyanate, 2,6-toluene diisocyanate, oligomeric isocyanate, isophorone diisocyanate, 4,4-diphenylpropane diisocyanate, xylene diisocyanate, and 1,1,6,6-tetramethylhexamethylene diisocyanate. The acrylates may include monounsaturated esters of (meth)acrylic acid with an unsubstituted alkyl radical that are suitable with particular preference are methyl (meth)acrylate, ethyl (meth)acrylate, propyl (meth)acrylate, isopropyl (meth)acrylate, n-butyl (meth)acrylate, isobutyl (meth)acrylate, tert-butyl (meth)acrylate, amyl (meth)acrylate, hexyl (meth)acrylate, ethylhexyl (meth)acrylate, 3,3,5-trimethylhexyl (meth)acrylate, stearyl (meth)acrylate, lauryl (meth)acrylate, cycloalkyl (meth)acrylates. Suitable monounsaturated esters of (meth)acrylic acid with a substituted alkyl radical may be substituted preferably by one or more hydroxyl groups, such as 2-hydroxyethyl (meth)acrylate, 2-hydroxypropyl (meth)acrylate, 3-hydroxypropyl (meth)acrylate, 3-hydroxybutyl (meth)acrylate and 4-hydroxybutyl (meth)acrylate, with 2-hydroxyethyl (meth)acrylate. The total mass of the (meth) acrylates preferably has a content of 5.0 wt. % to 70.0 wt. %, more preferably 30.0 wt. % to 50.0 wt. %, based on the total weight of the polyurethane-acrylic resin (B). And the (meth)acrylates selected such that the resulting polyurethane-acrylic resin (B) has a glass transition temperature Tg of from 5° C. to 45° C. and preferably from 10° C. to 40° C.

In some embodiments, the polyurethane-acrylic resin (B) preferably contains a mixed or crosslinked (meth)acrylic resin and the polyurethane resin.

It is more preferred that the acid groups contained in each of the (meth)acrylic resin and the polyurethane resin are partially crosslinked with the crosslinking agent.

In some embodiments of present invention, the aqueous dispersion of polyurethane-acrylic resin includes a polyester-polyurethane-poly (meth) acrylate, polyester-polycarbonate-polyurethane-poly(meth)acrylate, and corresponding derivatives.

In some embodiments of the present invention, the content of the polyurethane-acrylic resin in the protection coating composition is from 50 wt. % to 85% wt. %, or 55 wt. % to 80 wt. %, or 60 wt. % to 75 wt. %, based on the total weight of solid contents in the protection coating composition. The lower limit concentration of the polyurethane-acrylic resin in the protection coating composition is 50 wt. %, or 55 wt. %, or 60 wt. %. The upper limit concentration of the polyurethane resin is 85 wt. %, or 80 wt. %, or 75 wt. %.

Examples of commercially available polyurethane-acrylic resins are, for example, BS PUAW TT-10 and SGR-0215W from Shanghai Xinyang Chemical, or SGR-3002W from Changle Chemical, or Neopac E-123 and Neopac E-129 from DSM.

The above polyurethane-acrylic resins can be used alone or in any combinations.

In some embodiments of present invention, the above polyurethane-acrylic resin (B) and polyurethane resin (A) can be used alone or in any combinations. In some embodiments of the present invention, the content of the polyurethane-acrylic resin (B) and/or polyurethane resin (A) in the protection coating composition is from 50 wt. % to 85% wt. %, or 55 wt. % to 80 wt. %, or 60 wt. % to 75 wt. %, based on the total weight of solid contents in the protection coating composition. The lower limit concentration of the resin(s) in the protection coating composition is 50 wt. %, or 55 wt. %, or 60 wt. %, or 65 wt. %. The upper limit concentration of the resin(s) is 85 wt. %, or 80 wt. %, or 75 wt. %, or 70 wt. %.

### Bi-Functional Epoxy Resin Precursor (C)

The bi-functional epoxy resin precursor (C) of present invention can be commercially available or be prepared by known methods, such as reacting a bi-functional epoxy compound and a nucleophilic or electrophilic compound having active hydrogen atom.

In some embodiments of present invention, the bi-functional epoxy resin can react with polymer having hydroxyl group (—OH), polymer having ester group (—COOR), organic/inorganic acid containing heteroatoms (N, S, P), or amino compound to produce the bi-functional epoxy resin precursor (C).

The epoxy compound used in production is not particularly limited in type as far as it contains has at least two epoxy groups in the molecule.

Two epoxy groups could produce the two hydroxyl groups of the bi-functional epoxy resin precursor (C).

The bi-functional epoxy compound includes bisphenol A epoxy, bisphenol F epoxy, acryl modified epoxy, epoxy ester obtained by a reaction of epoxy and unsaturated fatty acid, urethane modified epoxy, silane modified epoxy, halogenated epoxy alkane such as epihalohydrin, phosphoric acid-modified epoxy resin and an epoxy compound having two or more glycidyl groups. The above epoxy resins may be used alone or may be used in combination of two or more. The epoxy resin of present invention has an epoxide equivalent weight of from about 100 grams/equivalent to about 2,000 grams/equivalent.

The rigidity and suitable flexibility derived from the polyhydroxyl and heteroatom structure units in the bi-functional epoxy resin precursor (C), which could improve the adhesion of the coating composition. Further, such structures are difficult to hydrolyze, and it can improve the adhesive ability, it can further improve the corrosion resistance of the coating composition. The hydroxyl groups in the bi hydroxyl functional epoxy resin precursor, due to their polarity, could strongly bond with metal substrate and help to improve the adhesion with the metallic substrate. Further, the heteroatom structure (O—C, N—C, S—C, P—C) can help to build strong bond with the metallic substrate, too. In the treating process of the coating composition, the hydroxyl groups in the epoxy resin precursor (C) cross-link with the zirconium compound and silanol group-containing compound whereby the chemical resistance and corrosion resistance of the coating are improved.

The epoxy resin precursor (C) is preferably used in the form of an aqueous dispersion thereof. The aqueous dispersion of the bi-functional epoxy resin precursor (C) may also contain a dispersant such as a surfactant, if required.

The weight molecular (ave.) of the bi-functional epoxy resin precursor (C) is preferably 200 to 10,000.

The pH value of the bi-functional epoxy resin precursor (C) is not particularly limited, but considered to improve stability and corrosion resistance, the prefer pH value is 6 to 9.

The content ratio of the bi-functional epoxy resin precursor (C) to the total mass of solid contents is preferably from 4.5 wt. % to 40 wt. %, or 4.5 wt. % to 35 wt. %, or 10 wt. % to 30 wt. %, or 10 wt. % to 25 wt. %, or 8.5 wt. % to 18.5 wt. %. If the solid content ratio is less than 4 wt. %, or less than 4.5 wt. % the T-bend test can't be passed; while if over 30 wt. %, or over 23 wt. % the chemical resistance will be impacted negatively.

The content ratio of the bi-functional epoxy resin precursor (C) to the total mass of resins (including polyurethane-acrylic resin (B), polyurethane resin (A), polyacrylic-epoxy resin (D) and bi-functional epoxy resin precursor (C)) is preferably from 7.0 wt. % to 30 wt. %, or 10.0 wt. % to 28 wt. %, or 10.5 wt. % to 27 wt. %, or 10.5 wt. % to 26 wt. %. If the content ratio is less than 7 wt. %, or less than 10.5 wt. % the T-bend test can't be passed; while if over 25 wt. %, or over 30 wt. % the chemical resistance will be impacted negatively.

In some embodiments, the epoxy resin can react with polymer having functional groups, organic/inorganic acid with heteroatoms (N, S, P) and amino to produce the bi-functional epoxy resin precursor.

In some embodiments, bisphenol A epoxy react with orthophosphoric acid and propylene glycol monomethyl ether to produce a phosphoric acid-modified epoxy resin.

In some embodiments, bisphenol A epoxy react with citric acid and propylene glycol monomethyl ether to produce a carboxyl group-modified epoxy resin.

In some embodiments, the bi-functional epoxy resin precursors have a formula as below:

R₁—Y—[CH₂—CH(OH)—R₃—CH(OH)—CH₂—X—R₄—X]ₙ—R₂

wherein, independently,
X=—COO—, sulphur moiety, —NR(H)—, —P(OR)₂—O—, —P(OR)(OH)—O—, —PO—O—; preferably being —COO—, —P(OR)(OH)—O—; the R group in —NR(H)—, —P(OR)₂—O—, —P(OR)(OH)—O— includes aliphatic chain having from 1 to 5 carbon atoms;
Y=—COO—, sulphur moiety, —NR(H)—, —P(OR)₂—O—, —P(OR)(OH)—O—, —PO—O—; preferably being —COO—, —P(OR)(OH)—O—; the R group in —NR(H)—, —P(OR)₂—O—, —P(OR)(OH)—O— includes aliphatic chain having from 1 to 5 carbon atoms;
R₂ being aromatic chain or aliphatic chain having from 1 to 20 carbon atoms or H; preferably being 1 to 10 carbon atoms or H;
R₄ being aromatic chain or aliphatic chain having from 1 to 20 carbon atoms; preferably being 1 to 10 carbon atoms;
R₁ being aromatic chain or aliphatic chain having from 1 to 20 carbon atoms, —XH or —X—R₄; preferably being 1 to 10 carbon atoms;
R₃ being any types of chain as far as it connects two hydroxyl α-carbon atoms; preferably R₃ being one selected from the group consisting of aromatic or aliphatic moiety having from 1 to 20 carbon atoms, polyurethane moiety, aliphatic or aromatic alkane having from 2 to 20 carbon atoms, acrylates containing polymer moiety.
n being an integer of 1˜10, preferably being an integer of 2˜8.

In some embodiments, the bi-functional epoxy resin precursors have a formula as below:

HX—R₄—X—[CH₂—CH(OH)—R₃—CH(OH)—CH₂—X—R₄—X]ₙ—H,

wherein, independently,
X=—COO—, —P(OR)(OH)—O—;
R₄ being aromatic chain or aliphatic chain having from 1 to 10 carbon atoms;
R₃ being any types of chain as far as it connects two hydroxyl α-carbon atoms;
n being an integer of 2˜8.

### Polyacrylic-Epoxy Resin (D)

The protection coating composition of present invention further comprises a polyacrylic-epoxy resin (D).

In some embodiments of present invention, the polyacrylic-epoxy resin (D) is an aqueous dispersion.

In some embodiments of present invention, the polyacrylic-epoxy resin (D) of the present invention including a carboxyl group-containing polymer containing a repeating unit derived from a carboxyl group-containing vinyl monomer. In other words, the polyacrylic-epoxy resin (D) contains the carboxyl group-containing polymer chain as a part of the structure.

The glass transition temperature (Tg) of the aqueous polyacrylic-epoxy resin (D) is not particularly limited and is preferably from 50° C. to 100° C. The method of producing the aqueous polyacrylic-epoxy resin (D) is not particularly limited, and any known method is applicable.

For example, epoxy resin is at least reacted with glycidyl group-containing vinyl monomers or amido group-containing vinyl monomers or amino group-containing vinyl monomers, and glycidyl ethers of polyalkylene glycols, here amine was added as the catalyst to obtain the carboxyl group containing vinyl monomer. And then polymerize the monomer and carboxyl group-containing vinyl monomer. For the glycidyl group-containing vinyl monomer may be used without limitation as long as it contains glycidyl group and polymerizable vinyl group in the molecule including glycidyl (meth) acylate, 3-methyl glycidyl (meth)acrylate and (meth)allyl glycidyl ether. For the amido group-containing vinyl monomer may be used without limitation as long as it contains amido group and polymerizable vinyl group in the molecule. including acrylamide, N-butoxymethyl(meth)acrylamide, N-methyl (meth)acrylamide, N,N-dimethyl(meth)acrylamide, N-isopropyl(meth)acrylamide, diacetone(meth)acrylamide and N-vinylformamide. For the amino group-containing vinyl monomer, it contains amino group and polymerizable vinyl group in the molecule, including 20 N,N-dimethylaminoethyl (meth)acrylate, N,N-diethylaminoethyl (meth)acrylate and N,N-dimethylaminopropyl (meth)acrylate.

In some embodiments of the present invention, the content of the polyacrylic-epoxy resin in the protection coating composition is from 35 wt. % to 60 wt. %, based on the total weight of the solid contents in the protection coating composition.

The above polyacrylic-epoxy resins can be used alone or in any combinations.

Examples of commercially available polyurethane-acrylic resins are, for example, aqueous polyurethane-epoxy resins MR1487W from KDD functional material; GS-5000B; GS-500D from Guangshu Chemical.

### Solvent

The protection coating composition of the present invention comprises a solvent, such as water, to dissolve all components to form the coating dispersion. Water is used to dilute the surface treatment composition of the invention, and it provides relatively long-term stability to the composition. For example, a composition that contains less than about 40% by weight of water is more likely to polymerize or “gel” compared to a surface treatment composition with about 60% or greater by weight water under identical storage conditions. Although the protection coating compositions of the invention typically applied to the substrate will contain about 70 wt. % water or greater, such as 85 wt. %, it is to be understood that a protection coating composition of the invention also includes a concentrated formulation composition with 50 wt. % to 85 wt. % water. The end-user simply dilutes the concentrated formulation with additional water to obtain an optimal protection coating composition concentration for a particular surface treatment application.

In some embodiments of the present invention, it is preferably to use deionized water as solvent. In some embodiments of present invention, the water content of the protection coating composition is 50 wt. % to 85 wt. %, or 60% wt. % to 85 wt. %, or 65% wt. % to 75 wt. %, based on the total weight of the protection coating composition.

The protection coating composition of the invention can be provided as a ready-to-use protection coating composition, as a concentrated protection coating composition that is diluted with water prior to use, as a replenishing composition, or as a multi-component coating system.

As used therein, “aqueous solution” refers to a protection coating composition containing at least 50 wt. %, or at least 60 wt. %, or at least 65 wt. % of water, based on the total weight of the composition. In addition to water, other suitable solvents include those that have found particular utility in water borne coating technologies. Examples of other suitable solvents include, but are not limited to, water-compatible solvent, such as alcohols or ethers, more detailly, methanol and ethanol, glycols, such as dipropylene glycol, and other glycol ethers, such as propylene glycol monobutyl ether and dipropylene glycol monobutyl ether.

### pH Value of the Protection Coating Composition

The pH value of the protection coating composition is greater than 7 to 12, or 7.5 to 12, or 8 to 12, or 8.1 to 11.5. The lower limit of pH value is 7.1, 7.5, 8.0, 8.1, or 8.2, or 8.5, or 8.8, or 9.0, or 9.2, or 9.5, or 10.0; the upper limit of pH value is 12, or 11.8, or 11.6, or 11.5, or 11.2, or 11.0. One or more optional pH-adjusting agents, including minor amounts of mineral acids, alkali components, and organic acids may be used to adjust the pH value to above desired operating pH value if needed. The protection coating composition with a basic operating pH value will lead to a better anti corrosion result.

The pH value of the aqueous protection coating solution is in the range of 7.1 to 12, preferably 8 to 12 and in other words, the aqueous surface treatment solution according to the present invention is an alkaline solution.

### Other Additives

The protection coating composition of the present invention may further comprise optional additives. The selection of suitable additives for the protection coating composition depends on the specific intended use and can be determined in the individual case by those skilled in the art. The optional additives include defoaming agent, sizing agent, flatting agent, thickening agent, inhibitor, pigment/filler, etc.

### <Wax>

The aqueous lubricant is not particularly limited in type, and examples thereof include polyolefin waxes such as polyethylene wax and polypropylene wax; paraffin waxes such as synthetic paraffin and natural paraffin; microcrystalline wax; and fatty acid amide compounds such as steer amide, palmitamide, methylenebisstearamide and oleamide. The aqueous lubricant/wax content is preferably 0.1 to 20 wt. % and more preferably 0.5 to 10 wt. % with respect to the solid content of the treating agent. With the aqueous lubricant content within the foregoing ranges, the protection coating composition provides more excellent lubrication and lower friction coefficient which is favorable.

### <Inorganic Inhibitor>

The zirconium compound is used as the coating-forming component to form a coating of a three-dimensionally cross-linked zirconium oxide by hydrolysis and condensation accompanied with desorption of volatile acids in the aqueous system during the curing process and can provide positive effect on the corrosion resistance and the force with the substrate. The zirconium compound selected should stabilized in the alkali aqueous solution. The zirconium compound is not particularly limited in type as long as it contains a zirconium atom, and examples thereof include basic zirconium carbonate, zirconium carbonate salts such as sodium zirconium carbonate, potassium zirconium carbonate, lithium zirconium carbonate, and ammonium zirconium carbonate, zirconium hydroxide, zirconium lactate, zirconium acetate, zirconium nitrate, zirconium sulfate, zirconium chloride, calcium zirconate, zirconium ethoxide, and zirconium hexafluoroacetylacetonato. Of these, zirconium ammonium carbonate and zirconium sodium carbonate are preferred in terms of excellent corrosion resistance. The zirconium compound is selected form ammonium zirconium carbonate, potassium zirconium carbonate, basic zirconium oxide and zirconium acetate.

Wherein the inorganic inhibitor is metal compound like vanadium compound. The metallic material may have a three-dimensional shape as in constructs made of sheet metal. The metal compound including the metal atom is not particularly limited in type as long as it contains the metal, and examples thereof include metal oxides and/or metal alkoxides containing metal atoms mentioned above. The supply source of metal ions may be at least one metal compound selected from, for instance, ammonium salts and acetonates of Mo, W, Y, Bi, Mn, La, Ce, Sm, Zn, AL, Si, Ni, Co, Zr, Mg, Ti and V. Of these, compounds that dissolve in an alkali solution are preferred. Such as Vanadium compound, for example, vanadium pentaoxide, vanadium trioxide, vanadium oxyacetyl acetonate, vanadium acetyl acetonate and so on.

The content mass ratio [M/silane] of the metallic material and organic silane is 1 to 5, preferably 2 to 4. If the solid content mass ration is less than 1, the effect on the corrosion resistance does not appear, while if the ration is higher than 5, the system is hard to keep stability and the chemical resistance will be impacted negatively.

In the aqueous protection coating composition solution, the inorganic inhibitor is present in an amount of from 1.5 wt. % to 5.0 wt. %, or from 2.0 wt. % to 4.0 wt. %, or from 1.5 wt. % to 4.0 wt. %, or from 2.0 wt. % to 5.0 wt. %, based on the weight of the solid contents in the protection coating composition.

### <Silane Compound>

The silane compound in the present invention comprises silanol group-containing compounds, which are hydrolysis of an organic silicone compound having a glycidoxyl group. The hydrolysis of the organic silicone can be processed at pH value a range of 8 to 10. As the hydrolysis aid, prefer is alkaline materials, such as aqueous ammonia and organic amine since it evaporates in the coating forming process and is difficult to remain in the 2 in 1 primer-pretreatment coating composition.

The protection coating composition in the present invention also comprises a silane compound as coupling agent. It is known in the art that silane coupling agents can be added in the surface coating compositions for metallic materials to improve the adhesiveness of the coating formed on the metal surface.

There is no limitation to the silane coupling agents to be used in the 2 in 1 primer-pretreatment coating compositions, as long as the silane coupling agents are compatible to the rare earth element containing compound, such as the water-soluble zirconium salts and other components contained.

The silane coupling agents may have an amino functional group or epoxy functional group. The amino or epoxy functional silane may comprise C2-C10 alkoxy groups.

The silane coupling agent may have the general structure R₁—Si—X₃, wherein R₁ is a reactive organofunctional group and at least one of X is a hydrolysable group and others are optionally substituted alkyl or an aryl group containing 1 to 10 carbon atoms. The hydrolysable group may be selected from alkoxy, acyloxy, halogen or amine. For example, the alkoxy may be a C1-C6 alkoxy (e.g., a methoxy or ethoxy group); the acyloxy may be a phenyloxy, and the halogen may be a chloride or a bromide.

R₁ may be an optionally substituted alkyl or an aryl group containing 1-10 carbon atoms, e.g., 2-10 carbon atoms. If R₃ is a substituted alkyl or an aryl group containing 1-10 carbon atoms, R₁ is preferably substituted with one or more amine or epoxy functional groups. In these cases, the silane coupling agent may then be described as an amino functional silane or an epoxy functional silane respectfully.

Some exemplary epoxy functional silanes include 3-glycidyloxypropyltrimethoxysilane, 3-glycidyloxypropyltriethoxysilane or beta-(3, 4-epoxycyclohexyl) ethyltrimethoxysilane.

Suitably, R₃ is an alkyl or an aryl group containing 1 to 10 carbon atoms substituted with one or more amine groups, or an aryl group (e.g., phenyl group) containing 5 to 10 carbon atoms substituted with one or more amine groups. The amine groups may be one or more primary, secondary or tertiary amine groups.

A suitable amine functional silane coupling agent for use in the surface treatment composition of the present invention has the structure: (R₂—O)₃—Si—R₃—NH₂, wherein R₂ is an alkyl group containing 1 to 10 carbon atoms, preferably 1 to 6 carbon atoms and most preferably is a methyl group, R₃ is an alkylene moiety containing 1 to 10 carbon atoms optionally substituted with an amine group. Examples of amine functional silane coupling agent are aminomethylaminopropyltrimethoxylsilane ((MeO)₃—Si—(CH₂)₃—NH—(CH₂)—NH₂), aminopropyltrimethoxysilane ((MeO)₃—Si—(CH₂)₃—NH₂), and/or aminopropyltriethoxysilane ((EtO)₃—Si—(CH₂)₃—NH₂).

Other examples of silane coupling agents suitable for the present invention include but not limited to 3-aminopropylmethyldiethoxysilane, 3-aminopropyltriethoxysilane, 4-aminobutyltriethoxysilane, 3-[2-(2-aminoethylamino) ethylamino]propyltrimethoxysilane, N-(2-aminoethyl)-3-aminoisobutylmethyldimethoxysilane, (aminoethylaminomethyl) phenethyltrimethoxysilane, N-(2-aminoethyl)-3-aminopropylmethyldimethoxysilane, N-(2-aminoethyl)-3-aminopropyltrimethoxysilane, N-(2-aminoethyl)-3-aminopropyltris (2-ethylhexoxy) silane, N-(6-aminohexyl) aminopropyltrimethoxysilane, m-aminophenyltrimethoxysilane, p-aminophenyltrimethoxysilane, o-aminophenyltrimethoxysilane, 3-aminopropyltrimethoxysilane, N-2-aminoethyl-3-aminopropyltrimethoxysilane, aminopropyltrimethoxysilane, aminopropylmethyldimethoxysilane, aminopropyltriethoxysilane, aminopropylmethyldiethoxysilane, aminophenyltrimethoxysilane, 4-amino-3-dimethylbutyltrimethoxysilane, 4-amino-3-dimethylbutylmethyldimethoxysilane, 4-amino-3-dimethylbutyltriethoxysilane, 4-amino-3-dimethylbutylmethyldiethoxysilane, N-phenyl-aminopropyltrimethoxysilane, N-naphthyl-aminopropyltrimethoxysilane, N-phenyl-aminopropylmethyldimethoxysilane, N-naphthyl-aminopropylmethyldimethoxysilane, N-(n-butyl) aminopropyltrimethoxysilane, N-(n-butyl) aminopropylmethyldimethoxysilane, N-ethyl-aminopropyltrimethoxysilane, N-ethyl-aminopropylmethyldimethoxysilane, N-methyl-aminopropyltrimethoxysilane, N-methyl-gamma aminopropylmethyldimethoxysilane, N-beta-(aminoethyl)-aminopropyltrimethoxysilane, N-beta-(aminoethyl)-aminopropyltriethoxysilane, N-beta (aminoethyl) aminopropylmethyldimethoxysilane, N-beta-(aminoethyl) aminopropylmethyldiethoxysilane, N-3-[amino (dipropyleneoxy)]aminopropyltrimethoxysilane, (aminoethylaminomethyl) phenethyltrimethoxysilane, N-(6-aminohexyl) aminopropyltrimethoxysilane, N-(2-aminoethyl)-11-aminoundecyltrimethoxysilane, bis (trimethoxysilylpropyl) amine, (3-trimethoxysilylpropyl) diethylenetriamine, (aminoethylamino)-3-isobutyldimethylmethoxysilane, (cyclohexylaminomethyl) triethoxysilane, (N, N-diethyl-3-aminopropyl) trimethoxysilane, (phenylaminomethyl) methyldimethoxysilane, 11-aminoundecyltriethoxysilane, 2-(2-pyridylethyl) thiopropyltrimethoxysilane, 2-(4-pyridylethyl) triethoxysilane, 2-(trimethoxysilylethyl) pyridine, 3-(1, 3-dimethylbutylidene) aminopropyltriethoxysilane, 3-(2-imidazolin-1-yl) propyltriethoxysilane, 3-(m-aminophenoxy) propyltrimethoxyaminopropylsilanetriol, 3-(m-aminophenoxy) propyltrimethoxysilane, 3-(N, N-dimethylaminopropyl) trimethoxysilane, 3-(N-allylamino) propyltrimethoxysilane, 3-aminopropyldiisopropylethoxysilane, 3-aminopropyldimethylethoxysilane, 3-aminopropylmethyldiethoxysilane, 3-aminopropyltriethoxysilane, 3-aminopropyltrimethoxysilane, 3-aminopropyltris (methoxyethoxyethoxy) silane, 4-aminobutyltriethoxysilane, acetamidopropyltrimethoxysilane, aminopropylsilanetriol, bis(2-hydroxyethyl)-3-aminopropyltriethoxysilane, bis(methyldiethoxysilylpropyl) amine, bis(methyldimethoxysilylpropyl) n-methylamine, bis(triethoxysilylpropyl) amine, bis(trimethoxysilylpropyl) urea, bis [(3-trimethoxysilyl) propyl]ethylenediamine, bis [3-(triethoxysilyl) propyl]urea, diethylaminomethyltriethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropylsilanetriol, n-(2-aminoethyl)-3-aminopropyltriethoxysilane, N-(2-aminoethyl)-3-aminopropyltrimethoxysilane, N-(3-aminopropyldimethylsila) aza-2, 2-dimethyl-2-silacyclopentane, N-(3-triethoxysilylpropyl) 4, 5-dihydroimidazole, N-(3-trimethoxysilylpropyl) pyrrole, N-(6-aminohexyl) aminomethyltriethoxysilane, N-(6-aminohexyl) aminomethyltrimethoxysilane, N, N, N-trimethyl-3-(trimethoxysilyl)-1-propanaminium, N, N-dioctyl-N′-triethoxysilylpropylurea, N-[5-(trimethoxysilyl)-2-aza-1-oxopentyl]caprolactam, N-3-[(amino (polypropylenoxy)]aminopropyltrimethoxysilane, N-butylaminopropyltrimethoxysilane, N-cyclohexylaminopropyltrimethoxysilane, N-ethylaminoisobutylmethyldiethoxysilane, N-ethylaminoisobutyltrimethoxysilane, N-phenylaminomethyltriethoxysilane, n-trimethoxysilylpropylcarbamoylcaprolactam, ureidopropyltriethoxysilane, ureidopropyltrimethoxysilane, and mixture thereof, and preferably is selected from N-2-aminoethyl-3-aminopropyltrimethoxysilane, 3-aminopropyltriethoxysilane, 3-aminopropyltrimethoxysilane, bis [3-(trimethoxysilyl) propyl]amine.

The amine functional silane coupling agent and/or epoxy functional silane coupling agent can be used alone or may be used in combination of two or more.

In the aqueous protection coating composition solution, the silane coupling agent is present in an amount of from 1.0 wt. % to 4.5 wt. %, or from 1.4 wt. % to 4.0 wt. %, or from 1.5 wt. % to 3.5 wt. %, or from 1.4 wt. % to 3.0 wt. %, or from 1.4 wt. % to 2.5 wt. %, based on the total weight of the solid contents of the protection coating composition.

The solid content mass ratio of the silane compound and zirconium compound converted to Zr is 0.1 to 3, preferably 0.2 to 1.5. When the mass ratio is too low, corrosion resistance cannot be obtained. While if more than 3, the stability and adhesion performance will be impacted negatively.

### <Filler/Pigment>

As the filler/color pigment, a known inorganic and organic coloring pigment can be used. As an inorganic pigment, titanium oxide (TiO₂), zinc oxide (ZnO), zirconium oxide (ZrO₂), calcium carbonate (CaCO₃), barium sulfate (BaSO₄), alumina (Al₂O₃), kaolin clay, carbon black and iron oxide (Fe₂O₃ and Fe₃O₄). As the organic pigment, Hanser yellow and pyrazolone orange pigment. It is used for improving the appearance performance after applying the finish coating and is not particularly limited. But the particle size of powder should be controlled under 10 μm, preferably under 3 μm. The weight ratio of pigment/filler to the organic polymer resin is from 0.05 to 1.0. When the ratio is too low, the covering ability cannot match the appearance requirements (color different and gloss); if the ratio is higher than 1.0, the filler will occur serious settlement and impacted negative on the appearance.

### <Other Additives>

The coating composition/solution can optionally comprise conventional additives known to a person skilled in the adhesive art. Conventional additives which are compatible with the disclosed surface treatment composition/solution may simply be determined by combining a potential additive with the composition and determining if they remain homogenous. Non-limiting examples of suitable additives include, without limitation, solvents, corrosion inhibitors, defoamers, surfactants, UV-stabilizers, extenders, plasticizers, and pigments as are known in the art.

The total level of additives will vary depending on amount of each particular additive needed to provide the coating composition/solution for light metallic material with desired properties. The level of additives can be from 0 to about 10%, and preferably from about 0.1 to about 5% by weight of the total weight of the protection coating composition.

### Preparing Method of the Bi-Functional Epoxy Resin Precursor

The bi-functional epoxy resin precursor might be prepared by repeating an addition reaction and condensation reaction of a bi-functional epoxy. The epoxy of present invention comprises used is not particularly limited in type as long as it contains two epoxy groups in the molecule, including bisphenol A, bisphenol F, and epichlorohydrin such as epihalohydrin and an epoxy compound having two or more glycidyl groups.

In some embodiments of the present invention, the bi-functional epoxy resin precursor is preferably prepared by steps of:

Reacting bi-functional epoxy with a nucleophilic or electrophilic compound having active hydrogen atom; adding a pH adjustor and water to the solution to obtain 5 wt. % to 32 wt. % solid content of the neutralized bi-functional epoxy resin precursor.

In some embodiments of the invention, the bi-functional epoxy resin precursor is presented by a formula as below:

R₁—Y—[CH₂—CH(OH)—R₃—CH(OH)—CH₂—X—R₄—X]ₙ—R₂

wherein, independently,
R₁ being aromatic chain or aliphatic chain having from 1 to 20 carbon atoms, preferred from 1 to 10 carbon atoms;
R₂ being aromatic chain or aliphatic chain having from 1 to 20 carbon atoms, preferred from 1 to 10 carbon atoms or H;
R₄ being aromatic chain or aliphatic chain having from 1 to 20 carbon atoms, preferred from 1 to 10 carbon atoms;
X=—COO—, sulphur moiety, —NR(H)—, —P(OR)₂—O—, —P(OR)(OH)—O—, —PO—O—, preferred being —COO—, —NR(H)—, —P(OR)₂—O—, —P(OR)(OH)—O—, —PO—O—; the R group in —NR(H)—, —P(OR)₂—O—, —P(OR)(OH)—O— includes aliphatic chain having from 1 to 5 carbon atoms;
Y=—COO—, sulphur moiety, —NR(H)—, —P(OR)₂—O—, —P(OR)(OH)—O—, —PO—O—, preferably being —COO—, —NR(H)—, —P(OR)₂—O—, —P(OR)(OH)—O—, —PO—O—; the R group in —NR(H)—, —P(OR)₂—O—, —P(OR)(OH)—O— includes aliphatic chain having from 1 to 5 carbon atoms;
R₃ being any types of chain as far as it connects two hydroxyl α-carbon atoms; preferred R₃ being one selected from the group consisting of aromatic or aliphatic moiety having from 1 to 20 carbon atoms, polyurethane moiety, aliphatic or aromatic alkane having from 2 to 20 carbon atoms, acrylates containing polymer moiety.
n being an integer of 1˜10, preferred being an integer of 2˜8.

### Preparing Method of the Protection Coating Composition

The protection coating composition may be prepared by dispersing all resin materials, inorganic inhibitors, silane coupling agent and other raw materials including color pigment in water or in a water-soluble solvent to prepare the protection coating composition. The solid content is adjusted by removing the solvent and volatile components. The solvent is usually water, some water-based solvent (such as alcohol, ketone, and cello solve-based water-soluble organic solvent) with a small amount can be used in combination to reduce film forming time. The solid content concentration of the aqueous protection coating composition is not particularly limited, but it is preferably in range of 15 wt. % to 50 wt. %, or 15 wt. % to 40 wt. %, or 25 wt. % to 35 wt. %.

The method for forming the intermediate layer is not particularly limited. For example, roll coater, dipping and spray, then dried by hot air oven, induction heating furnace and IR heater. The peak steel sheet temperature is 40˜150° C., but preferably in range of 50 to 80° C.

In some embodiments of the present invention, the protection coating composition is preferably prepared by steps of:
a) dissolving resin compounds and other compounds in water with stirring so as to obtain a solution,
b) adjusting to the solution obtained in step a) to achieve a proper pH for the solution by ammonia solution. The solution preferably has a pH from 8 to 12, preferably from greater than 9 to 12, or more preferably from 9 to 10.
c) adding the silane coupling agent with stirring to achieve the equilibrium of hydrolysis and condensation.
d) adding wax if needed with stirring uniform solution without delamination.

### Method for Coating and Curing on an Aluminum Alloy Surface

The method according to the invention is particularly suitable for coating metal sheets that are selected from sheets of zinc or zinc alloys, aluminum or aluminum alloys as well as steel strips that are coated with zinc or zinc alloys, or with aluminum or aluminum alloys. Here, “zinc alloys” or “aluminum alloys” are understood to mean those alloys that consist of more than 50 atoms % zinc or aluminum.

For test plates, the materials of (i) to (ii) were used as below.
i. Electrogalvanized steel sheet (EG): sheet thickness, 0.8 mm; coating weight, 40/20 g/m².
ii. Galvanized steel sheet (GA): sheet thickness, 0.8 mm; coating weight, 90/45 g/m².

Test plates were treated according to steps (1) to (5) as below.
1) degreasing the metal surface of plate,
2) rinsing with tap water,
3) drying the metal surface by compressed air,
4) roller coating the coating composition on the surface of plate,
5) curing the coating composition by hot air or in an oven,
   wherein, during the step (5), the temperature is preferably at least 75° C., but not more than 240° C., preferably not more than 150° C.

In some embodiments of present invention, the coating composition for treating the metallic plate was applied with a bar coater on the fresh surface of the metallic plate, dried the test plate in a hot air dryer so that the test plate had peak metal temperatures (PMT) of 95° C.

### Measurement of Coating Thickness

In the measurement of coating thickness, cross-section samples were first produced using X-ray spectrometer (ZSX Primus III+; Rigaku Corporation from Japan). Three spots of the panel are chosen to test the coating thickness. The minimum value is the lower limit, and the maximum is the upper limit.

The dry film thickness is 0.5˜4.0 μm. Preferred film thickness is 1.0˜3.0 μm.

### Formation of Top Coating Layer

After forming the primary coating layer (the cured protection coating composition), the top coating material was coated by a bar coater to a dried thickness of 15 μm, then the sample was heated to dry in a hot air-drying furnace to a peak plate temperature of 230° C. The top coating is selected the polyurethane paint for household applications from Nippon.

### Listing of Embodiments

1: A protection coating composition comprises:
   a. at least one resin, the resin being selected from a group consisting of polyurethane resin (A), polyurethane-acrylic resin(B),
   b. water, and
   c. a bi-functional epoxy resin precursor (C), the bi-functional epoxy resin precursor (C) being represented by the following formulas:

R₁—Y—[CH₂—CH(OH)—R₃—CH(OH)—CH₂—X—R₄—X]ₙ—R₂
wherein, independently,
X=—COO—, sulphur moiety, —NR(H)—, —P(OR)₂—O—, —P(OR)(OH)—O—, —PO—O—;
Y=—COO—, sulphur moiety, —NR(H)—, —P(OR)₂—O—, —P(OR)(OH)—O—, —PO—O—;
R₂ being aromatic chain or aliphatic chain having from 1 to 20 carbon atoms or H;
R₄ being aromatic chain or aliphatic chain having from 1 to 20 carbon atoms;
R₁ being aromatic chain or aliphatic chain having from 1 to 20 carbon atoms, —XH or —X—R₄;
R₃ being any types of chain as far as it connects two hydroxyl α-carbon atoms;
n being an integer of 1˜10.
2: The protection coating composition according to embodiment 1, wherein, independently, R₂ being aromatic chain or aliphatic chain having from 1 to 10 carbon atoms or H, R₄ being aromatic chain or aliphatic chain having from 1 to 10 carbon atoms, R₁ being aromatic chain or aliphatic chain having from 1 to 10 carbon atoms, —XH or —X—R₄.
3: The protection coating composition according to any one of preceding embodiments, wherein R₃ being selected from the group consisting of aromatic or aliphatic moiety having from 1 to 20 carbon atoms, polyurethane moiety, aliphatic or aromatic alkane having from 2 to 20 carbon atoms, acrylates containing polymer moiety.
4: The protection coating composition according to any one of preceding embodiments, wherein X being selected from —COO—, —P(OR)(OH)—O—; and n being an integer of 2˜8.
5: The protection coating composition according to any one of preceding embodiments, wherein, the bi-functional epoxy resin precursor (C) being represented by the following formulas:

(H)X—R₄—X—[CH₂—CH(OH)—R₃—CH(OH)—CH₂—X—R₄—X]ₙ—H
wherein, independently,
X=—COO—, —P(OR)(OH)—O—;
R₄ being aromatic chain or aliphatic chain having from 1 to 10 carbon atoms;
R₃ being any types of chain as far as it connects two hydroxyl α-carbon atoms;
n being an integer of 2˜8.
6: The protection coating composition according to claim 1, wherein components c) are present in 4.5 wt. % to 35 wt. %, preferably 4.5 wt. % to 23 wt. %, more preferably 8.5 wt. % to 18.5 wt. %, based on the total weight of the solid contents in the protection coating composition.
7: The protection coating composition according to claim 1, wherein the content ratio of the bi-functional epoxy resin precursor (C) to the total mass of polyurethane-acrylic resin (B), polyurethane resin (A), polyacrylic-epoxy resin (D) and bi-functional epoxy resin precursor (C) is from 7.0 wt. % to 30 wt. %, preferably from 10.5 wt. % to 27.0 wt. %.
8: The protection coating composition according to any one of preceding embodiments, wherein the protection coating composition further comprises a polyacrylic-epoxy resin (D).
9: The protection coating composition according to any one of preceding embodiments, wherein the protection coating composition further comprises 1.0 wt. % to 4.5 wt. %, preferably 1.4 wt. % to 2.5 wt. % of a silanol group containing resin, based on the total weight of solid contents, the silanol group containing resin being represented by the following formulas XY(Z)ₙSi(OH)₃₋ₙ, wherein, independently, X being a glycidoxy group or functional group derived from a glycidoxy group, Y being a C1 to C10 alkylene group, Z being a methoxy group, ethoxy group or methyl group, and n being an integer of 0 to 2.
10: The protection coating composition according to any one of preceding embodiments, wherein the protection coating composition further comprises 0.1 to 3 wt. % of a wax, based on the total weight of the protection coating composition.
11: The protection coating composition according to any one of preceding embodiments, wherein the protection coating composition further comprises 1 to 20 wt. % of a filler, based on the total weight of the solid contents in the composition.
12: The protection coating composition according to any one of preceding embodiments, wherein the protection coating composition further comprises, 1.5 to 5 wt. % of a metallic inhibitor, based on the total weight of solid contents in the composition, the metallic inhibitor comprising a zirconium compound selected from a group consisting of ammonium zirconium carbonate, potassium zirconium carbonate, basic zirconium carbonate, zirconium acetate, and combination.
13: The protection coating composition according to any one of preceding embodiments, wherein the pH value of the protection coating composition is from greater than 7 to 12.
14: The protection coating composition according to any one of preceding embodiments, wherein the pH value of the protection coating composition is from equal to or greater than 8 to 10.
15: The protection coating composition according to any one of preceding embodiments, wherein the solid content of the protection coating composition is 15 wt. % to 50 wt. %, based on the total weight of the protection coating composition.
16: The protection coating composition according to any one of preceding embodiments, wherein the solid content of the protection coating composition is 25 wt. % to 35 wt. %, based on the total weight of the protection coating composition.
17: A method for providing anticorrosion protection and enhanced coating adhesion on a metallic surface, comprising steps of:
   a. bringing the protection coating composition according to any one of embodiments 1 to 16 into contact with a metallic surface at a process temperature of at least 40° C., but no higher than 200° C., thereby creating a film on the metallic surface;
   b. optionally removing excess quantities of the protection coating composition from the surface; and
   c. curing the film located on the surface by means of thermal methods at a process temperature of 50-90° C., or high-energy irradiation for a period of at least 10-5 seconds to form a cured coating.
18: The method according to embodiment 17, wherein the cured coating exhibits a layer thickness of at least 0.5 μm, but of no more than 4.0 μm.
19: An article having at least one portion that comprises the treated metallic surface of embodiment 17.
20: The article of embodiment 19, wherein protection coating exhibits a layer thickness of at least 0.5 μm, but of no more than 4.0 μm.
21: The article of any one of embodiments 19-20, said treated metallic surface has a T-bend (fresh) of equal to or less than 1 T when subjected to GB/T13448-2006, a T-bend (aged, after 24 hours aging at a temperature of 50±2° C. and a humidity of 95%) of equal to or less than 2 T when subject to GB/T13448-2006.
22: An article having at least one portion that comprises a protection coating, wherein the protection coating is a cured product of the protection coating composition according to any one of embodiments 1 to 16.
23: The article of embodiment 22, wherein protection coating exhibits a layer thickness of at least 0.5 μm, but of no more than 4.0 μm.

### EXAMPLES

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Description/function | Product name | Source |
|---|---|---|
| Polyurethane resin (A)/ | Hauthane L-3528 | C.L. Hauthaway & Sons |
| polycarbonate-based aliphatic PU | | Corporation; US |
| Polyurethane resin (A)/ | Hauthane L-3529 | C.L. Hauthaway & Sons |
| polycarbonate-based aliphatic PU | | Corporation; US |
| Polyurethane resin (A)/ | Esacote PU A32D | LAMBERTI S.p.A.; Italy |
| polycarbonate-based aliphatic PU | | |
| Polyurethane resin (A)/hydroxyl | Leasys 5531 | Wanhua Chemical |
| functional polyurethane dispersion | | |
| Polyurethane resin (A)/hydroxyl | Leasys 3900 | Wanhua Chemical |
| functional polyurethane dispersion | | |
| Polyurethane-acrylic resin(B) | BS PUAW TT-10 | Shanghai Xinyang Chemical |
| Polyacrylic-epoxy resin (D) | MR1487W | KDD functional material (local |
| | | company) |
| Epoxy resin | YD-128A | KUKDO Chemical (kunshan) |
| | | CO., Ltd |
| Citric acid monohydrate | — | Sinopharm chemical reagent Co., |
| | | Ltd |
| Glycol Diether | PROGLYD DMM | DOW CHEMICAL (CN) COMPANY |
| | Glycol Diether | LIMITED |
| 28% aqueous ammonia | GR level | Sinopharm chemical reagent Co., |
| | | Ltd |
| 3-glycidoxypropyltriethoxysilane | JH-O1871 | HUBEI JIANGHAN NEW |
| | | MATERIALS |
| 3- | Dynasylan GLYEO | EVONIK |
| glycidoxypropylmethyldiethoxysilane | | |
| Ammonium zirconium carbonate | Zircosol AC 20 | Daiichi Kigenso Kagaku Kogyo |
| Zirconium acetate | Zirconium (IV) | Sinopharm chemical reagent Co., |
| | acetate | Ltd |
| Vanadium pentaoxide | Vanadium (V) oxide | Sinopharm chemical reagent Co., |
| | | Ltd |
| Vanadium acetyl acetonate | Vanadium (3) | Sigma Aldrich |
| | acetylacetonate | |
| TiO₂ | Rutile R996 | Yuejiang Chemical |
| CaCO₃ | Pigment White 18 | Sinopharm chemical reagent Co., |
| | | Ltd |

All raw materials are directly used without any special treatment.

### Example 1

### <Preparation of Bi-Functional Epoxy Resin Precursor>

Bi-functional epoxy resin precursor C1 was synthesized by steps of: Loaded Adipic acid and 40 g propylene glycol monomethyl ether into a 100 ml round bottom four-necks flask and heated at 90° C. Then added 260 g A-type epoxy liquid resin YD-128A (from Guodu) having 190 epoxy equivalent slowly and kept the temperature at 95° C. for 2 hours. After the reaction, added 28 wt. % aqueous ammonia solution 180 g slowly at 40° C., then added water to obtain a 5%-32% solid content of the ammonia neutralized bi-functional epoxy resin precursor C1. Bi-functional epoxy resin precursor C1 had a weight-average molecular weight of 13,000.

Bi-functional epoxy resin precursor C2 was synthesized by steps of:

The orthophosphoric acid and 100 g propylene glycol monomethyl ether was slowly added into the 1250 g A-type epoxy resin having 500 epoxy equivalent and kept at 95° C. for 2 hours. After the reaction, 28% aqueous ammonia solution 40 g was added slowly at 140° C., water was then added to obtain a 5%-32% solid content of the ammonia neutralized phosphoric acid-modified bi-functional epoxy resin precursor C2. The Bi-functional epoxy resin precursor (C2) had a weight-average molecular weight of 20,000.

### <Preparation of Protection Coating Composition>

Protection coating composition was prepared by steps of:
a) Charged 45 g of Hauthane L-3528 (liquid, from Hauthaway), 8 g of bi-functional epoxy resin precursor (produced as above), 0.5 g of Dynasylan GLYEO (liquid, from Evonik), 0.6 g of Zirconium (IV) acetate (liquid, from Sinopharm chemical reagent Co., Ltd), mixed them to form an aqueous dispersion.
b) Charged 12 g of Rutile R996 (liquid, from Yuejiang) in the aqueous dispersion made in step a).

### <Coating & Curing of Aluminum Alloy Surface>

### Test Material

Galvanized steel sheet (GA): sheet thickness, 0.8 mm; coating weight, 90/45 g/m²;

The process of electroless metal surface treatment preferably comprises the following subsequent steps (1)-(5):

Degreased the metal surface with RIDOLINE1559 degreasant from Henkel.
rinsed with tap water.
dried the metal surface by compressed air.
roller coated primer/pretreatment on the substrate.
cured by hot air/oven.
wherein, during the step (5), the temperature is about 85° C.

The protection coating composition was applied with a bar coater on the fresh substrate, dried in a hot air dryer so that the test plates had peak metal temperatures (PMT) 95° C.

In the measurement of coating thickness, cross-section samples were first produced using X-ray spectrometer (ZSX Primus III+; Rigaku Corporation from Japan.). Three spots of the panel are cut/choose to test/detect the coating thickness. The minimum value is the lower limit, and the maximum is the upper limit.

The dry film thickness range is from 1.2 μm to 1.7 μm.

After forming the primary layer, the top coating material was coated by a bar coater to a dried thickness of 15 μm, next, the sample was heated to dry in a hot air-drying furnace to a peak plate temperature of 230° C. The top coating is a polyurethane paint for household from Nippon.

### Example 2-18, and CE1-CE19

The coating compositions of E2 to E18 and CE1 to CE19 were prepared in reference to Example 1. The metallic surface of E2 to E18 and CE1 to CE19 were treated in reference to Example 1. More details are listed in below result part.

The prepared samples were subjected to various of tests.

### Test Methods

### Adhesion Ability

### <T-Bend (Fresh)> and <T-Bend (Aged)>

A T-bend tester is adopted to perform 180-degree bending tests according to the requirements of a bending test method in GB/T13448-2006 color coated steel plate and steel strip test method. Meanwhile, the samples were put into a test chamber, set temperature at 50±2° C. and humidity of 95% for 24 hours of accelerated aging test, and after the samples were taken out, a T-bend test (aged T-bend) was performed. The equipment for T-bend test is WZJ-II T-bend form Shanghai Xiandai Environment Engineering Technique Co., Ltd.

T-bend (fresh) results are recorded and ranked as follows:
Not pass: greater than 1 T.
Pass: lower than or equal to 1 T.
Good: equal to 0 T.

T-bend (aged) results are recorded and ranked as follows:
Not pass: greater than 2 T.
Pass: lower than or equal to 2 T.
Good: lower than or equal to 1 T.
Excellent: equal to 0 T.

### <Cross-Cupping Test>

The cross-cupping tests were carried out by a cup bursting test machine according to the requirements of the bending test in GB/T13448-2006 color coated steel plate and steel strip test method. The equipment is Electrohydraulic cupping tester Cat. No. 5400 from BYK-Gardner GmbH.

Cross-cupping test results are recorded and ranked as follows:
Not pass (F): peeled area is greater than 5%.
Pass (P): peeled area is lower than or equal to 5%.
Good (G): peeled area is lower than or equal to 2%.
Very Good (VG): peeled area is equal to 0%.

### <Reverse Impact Test>

Reverse impact test is dropped onto the strip from a height that is 3 times the metal thickness. The deformed surface is examined for cracks or breaks in the coating. Then tape is applied to the deformed area, then removed. If any coating is removed from the surface of the strip, the sample has failed the test. The energy impact test instrument is Elcometer 1615. The weight of heavy hammer is 1 Kg and height is 90 cm, the impact energy is 9J.

Evaluation criteria:
Good (G): no painting peels off and no crack.
Not pass (F): has crack or has painting peel off.

### Anti-Corrosion Ability

### <Cross Neutral Salt Spray Test 240 Hrs>

Each test plate (150 mm×70 mm) with cross “X” cutting was tested by Neutral salt spray test (GBT10125-1997), 240 hours for household and 1000 hours for architecture. The cutting line is longer than 50 mm. The swelling width of cross (maximum value) was measured and evaluated in accordance with the following criteria. The equipment for the corrosion test is Q-fog SSP salt spray chamber form Q-Lab Corporation. Trimming guard: stage 10 specified in GB/T6461.
Very good (VG): lower than or equal to 1 mm.
Good (G): lower than or equal to 2 mm.
Pass (P): lower than or equal to 3 mm.
No pass (F): greater than 3 mm.

### <Plate Neutral Salt Spray Test 500 Hrs>

Each test plates (150 mm×70 mm) were tested by Neutral salt spray test (GBT10125-1997) for 500 hrs (household) and examined by the naked eye and evaluated by the following.

Evaluation criteria:
Very good (VG): No blisters.
Good (G): single blister size of less than 1.0 mm and generation number is less than 5.
Pass (P): single blister size of less than 1.0 mm and generation number is equal to or greater than 5 and less than 10.
No pass (F): single blister size is equal to or greater than 1.0 mm and generation number is equal to or greater than 10 and less than 20.

### <Scrap Edge Neutral Salt Spray Test 240 Hrs>

Each test plate (150 mm×70 mm) with scrap edge were tested by Neutral salt spray test (GBT10125-1997) for 240 hours (household) and examined by the naked eye and evaluated by the following.

Evaluation criteria:
Very good (VG): less than or equal to 3 mm.
Good (G): less than or equal to 6 mm.
Pass (P): greater than 6 mm and less than 10 mm.
Not pass (F): equal to or greater than 10 mm.

### Solvent Resistance

### <Surface Resistance (MEK) Solvent Wipe>:

The equipment is DJH MEK Rub Test Machine from DJH Designs Inc. Set the speed of 1 to-fro per second with the 0.1±0.02 MPa and the test length not less than 150 mm.

Evaluation criteria:
Good (G): no mark or have wipe mark and no paint peel.
No pass (P): has top paint peel.

### Chemical Resistance

### <Alkali Resistance>

Each test plate was immersed in a 5 wt. % NaOH aqueous solution at RT for 24 hrs. Then the size and the generation density of the blisters generated were examined by the naked eye and evaluated for alkali resistance by the following.

Evaluation criteria:
Very good (VG): No blisters.
Good (G): single blister size of less than 1.0 mm and generation number is less than 5.
Pass (P): single blister size of 1.0 mm and generation number is equal to or greater than 5 and less than 10.
No pass (F): single blister size of 1.0 mm or more or generation number is greater than 10.

### <Sulfuric Acid Resistance Test> and <Hydrochloric Acid Resistance Test>

Each test plate was immersed in a 5 wt. % sulfuric acid aqueous solution at room temperature for 24 hrs, then the size and generation density of the blisters generated were examined by the naked eye and evaluated by criteria similar to the alkali resistance.

Each test plate was immersed in a 5 mass % hydrochloric acid aqueous solution at room temperature for 24 hrs, then the size and generation density of the blisters generated were examined by the naked eye and evaluated by criteria similar to the alkali resistance.
Very good (VG): No blisters
Good (G): single blister size of less than 1.0 mm and generation number is less than 5.
Pass (P): single blister size of 1.0 mm and generation number is equal to or greater than 5 and less than 10.
No pass (F): single blister size of 1.0 mm or more or generation number is greater than 10 Appearance

### <Gloss>

Gloss is measured with a gloss meter. The gloss meter illuminates the surface of the coating to confirm that the coating gloss is within a set range (standard ±5). The Gloss instrument is BYK 4563 from BYK-Gardner GmbH.

Evaluation criteria:
Good (G): the deviation compared to the standard is less than 3.
Not pass (F): the deviation compared to the standard is equal to or greater than 3.

### <Color Difference>

Color difference is measured with a color different equipment, the equipment illuminates the surface of the coating to confirm that the color different is within a set range (standard ±5). The equipment for color difference is HunterLab Agera from Eutin Internation Trading Co., Ltd.

Evaluation criteria:
Good (G): the range is equal to or less than 3.
No pass (F): the range is more than 3.

### Hardness

### <The Topcoat Pencil Hardness>

The hardness of top coating/varnish was tested as the standard GB/T6739-2006. The instrument is TQC VF2378 form H. J. Unkel (Shanghai) International Trading Co., Ltd.

Pass: equal to or harder than HB (GB/T6739-2006, zhonghua pencil 101).
Not Pass: softer than HB.

TABLE 1
Results

| | E1 | E2 | E3 | E4 | E5 | E6 | E7 | E8 | E9 | E10 | E11 | E12 | E13 |
|---|---|---|---|---|---|---|---|---|---|---|---|---|---|
| Hauthane L-3528 | | | | | | 17.5 | | | | | | | |
| Hauthane L-3529 | | | | | | | 17.5 | | | | | | |
| Leasys 5531 | | | | | | | | 20 | | | | | |
| Leasys 3900 | | | | | | | | | 25 | | | | |
| Esacote PU A32D | 17.5 | 17.5 | 17.5 | 17.5 | 17.5 | | | | | | | | 17 |
| BS PUAW TT-10 | | | | | | | | | | 17.5 | 17.5 | 15 | |
| C1 | 3.5 | 3.5 | 2.5 | | | 3.5 | 3.5 | 3.5 | 3 | 3.5 | 3.5 | 5 | 4 |
| C2 | | | | 3.5 | 3.5 | | | | | | | | |
| GS-500D | | | | | | | | | | | | | 2.5 |
| JH-O1871 | 0.5 | | 0.5 | 0.5 | | 0.5 | | 0.5 | 0.5 | 0.5 | | | 0.5 |
| Dynasylan GLYEO | | 0.5 | | | 0.5 | | 0.5 | | | | 0.5 | 0.5 | |
| Zircosol AC 20 | 0.6 | | 0.6 | 0.6 | | 0.6 | | 0.6 | 0.6 | 0.6 | | | 0.6 |
| Zirconium (IV) acetate | | 0.6 | | | 0.6 | | 0.6 | | | | 0.6 | 0.6 | |
| Vanadium (V) oxide (99%) | | 0.2 | | | 0.2 | | 0.2 | | | | 0.2 | 0.2 | |
| Vanadium (3) | 0.2 | | 0.2 | 0.2 | | 0.2 | | 0.2 | 0.2 | 0.2 | | | 0.2 |
| acetylacetonate | | | | | | | | | | | | | |
| Rutile R996 | 6 | | 6 | 6 | | 6 | | 6 | 6 | 6 | | | 6 |
| Pigment White 18 | | 6 | | | 6 | | 6 | | | | 6 | 6 | |
| Solid total | 28.3 | 28.3 | 27.3 | 28.3 | 28.3 | 28.3 | 28.3 | 30.8 | 35.3 | 28.3 | 28.3 | 27.3 | 30.8 |
| Composition total | 100 | 100 | 100 | 100 | 100 | 100 | 100 | 100 | 100 | 100 | 100 | 100 | 100 |

Table 1 shows compositions of the protection coating compositions E1-E13.

TABLE 2

| | E1 | E2 | E3 | E4 | E5 | E6 | E7 | E8 | E9 | E10 | E11 | E12 | E13 |
|---|---|---|---|---|---|---|---|---|---|---|---|---|---|
| Film thickness (μm) | 1.2~1.7 | 1.2~1.7 | 1.2~1.7 | 1.2~1.7 | 1.2~1.7 | 1.2~1.7 | 1.2~1.7 | 1.2~1.7 | 1.2~1.7 | 1.2~1.7 | 1.2~1.7 | 1.2~1.7 | 1.2~1.7 |
| Cross Neutral salt spray | G | VG | G | G | G | G | VG | VG | VG | G | G | VG | G |
| test 240 hrs | 0~2 mm | 1 mm | 1~2 mm | 1~2 mm | 1~2 mm | 1~2 mm | 1 mm | 1 mm | 1 mm | 1~2 mm | 2 mm | 1 mm | 0~2 mm |
| Plate Neutral salt spray | VG | VG | G | VG | VG | VG | VG | VG | VG | VG | VG | VG | VG |
| test 500 hrs | | | | | | | | | | | | | |
| Scrap edge Neutral | VG | VG | G | VG | VG | VG | VG | VG | VG | VG | G | VG | VG |
| salt spray test 240 hrs | 1~3 mm | 1~3 mm | 3~5 mm | 1~3 mm | 1~3 mm | 1~3 mm | 1~3 mm | 1~3 mm | 1~3 mm | 1~3 mm | 3~5mm | 1~3 mm | 1~3 mm |
| T-bend test (fresh) | 0 T | 0 T | 1 T | 1 T | 1 T | 0 T | 0 T | 0 T | 0 T | 1 T | 1 T | 1 T | 0 T |
| T-bend test (aged) | 0 T | 0 T | 2 T | 1 T | 1 T | 1 T | 0 T | 1 T | 1 T | 2 T | 2 T | 2 T | 0 T |
| Cross-hatch and | VG | VG | G | VG | G | VG | VG | VG | VG | G | G | G | VG |
| cupping test | 0% | 0% | <2% | 0% | 0% | 0% | 0% | 0% | 0% | <2% | 2% | <2% | 0% |
| Reverse Impact Testing | G | G | G | G | G | G | G | G | G | G | G | G | G |
| MEK rub test | G | G | G | G | G | G | G | G | P | G | G | G | G |
| Alkali resistance | VG | G | G | G | P | P | P | P | P | P | P | P | G |
| Sulfuric acid resistance | VG | P | G | G | P | G | G | G | G | P | P | G | G |
| test | | | | | | | | | | | | | |
| Hydrochloric acid | VG | P | G | G | P | G | G | G | G | P | P | G | G |
| resistance test | | | | | | | | | | | | | |
| Gloss | G | G | G | G | G | G | G | G | G | G | G | G | G |
| Color different | G | G | G | G | G | G | G | G | G | G | G | G | G |
| The topcoat pencil | P ≥ | P ≥ | P ≥ | P ≥ | P ≥ | P ≥ | P ≥ | P ≥ | P ≥ | P ≥ | P ≥ | P ≥ | P |
| hardness | HB | HB | HB | HB | HB | HB | HB | HB | HB | HB | HB | HB | H |

Table 2 shows testing results of the protection coating compositions E1-E13.
In Examples 1 to 13, the protection coating compositions were prepared according to the formulations provided by the present invention and have adhesion properties, even after aging, the adhesion properties are still meet the requirements. In addition, E1-E13 have excellent anti-corrosion properties.

TABLE 3

| | CE1 | CE2 | CE3 | CE4 |
|---|---|---|---|---|
| Esacote PU A32D | 17.5 | 12.5 | 12.5 | 11.5 |
| BS PUAW TT-10 | 1 | 6 | 7 | 10 |
| C1 | | | | |
| JH-O1871 | 0.5 | | 0.5 | 0.5 |
| Dynasylan GLYEO | | 0.5 | | |
| Zircosol AC 20 | 0.6 | | 0.6 | 0.6 |
| Zirconium (IV) acetate | | 0.6 | | |
| Vanadium (V) oxide: (99%) | | 0.2 | | |
| Vanadium (3) acetylacetonate | 0.2 | | 0.2 | 0.2 |
| Rutile R996 | 6 | | 6 | 6 |
| Pigment White 18 | | 6 | | |
| Solid total | 25.8 | 25.8 | 26.8 | 28.8 |
| Composition total | 100 | 100 | 100 | 100 |

Table 3 shows the compositions of the comparative examples CE1-CE4.

TABLE 4

| | CE1 | CE2 | CE3 | CE4 |
|---|---|---|---|---|
| Film thickness (μm) | 1.2~1.7 | 1.2~1.7 | 1.2~1.7 | 1.2~1.7 |
| Cross Neutral salt spray | F | G | G | G |
| test 240 hrs | 3~4 mm | 2 mm | 1~2 mm | 1~2 mm |
| Plate Neutral salt spray | G | VG | VG | VG |
| test 500 hrs | | | | |
| Scrap edge Neutral salt | G | G | G | F |
| spray test 240 hrs | 3~5 mm | 3~5 mm | 6 mm | 15 mm |
| T-bend test (fresh) | 2T | 1T | 1T | 1T |
| T-bend test (aged) | 3T | 2T | 1T | 1T |
| Cross-hatch and cupping test | F | VG | G | G |
| | 10% | 0% | <2% | <2% |
| Reverse Impact Testing | F | G | G | G |
| MEK rub test | F | G | G | G |
| Alkali resistance | G | F | F | F |
| Sulfuric acid resistance test | G | F | G | G |
| Hydrochloric acid | G | F | G | G |
| resistance test | | | | |
| Gloss | G | G | G | G |
| Color different | G | G | G | G |
| The topcoat pencil hardness | P ≥ HB | P ≥ HB | F = B | F = B |

Table 4 shows testing results of the comparative examples CE1-CE4.

TABLE 5

| | | | | | | CE | CE | CE | CE | |
|---|---|---|---|---|---|---|---|---|---|---|
| | CE5 | CE6 | CE7 | CE8 | CE9 | 10 | 11 | 12 | 13 | E14 |
| Leasys 5531 | | | | 10 | | 10 | | | | |
| Hauthane L-3528 | | | 20.5 | 10 | 10 | | | | | 17.5 |
| BS PUAW TT-10 | 20.5 | | | | 10 | | 10 | | | |
| Bi-functional epoxy | | | | | | | | 3.5 | 3.5 | 3.5 |
| resin precursor (C1) | | | | | | | | | | |
| Bi-functional epoxy | | | | | | | | | | |
| resin precursor (C2) | | | | | | | | | | |
| MR1487W | | 20 | | | | 10 | 10 | 17.5 | 17.5 | |
| JH-O1871 | 0.5 | 0.5 | 0.5 | 0.5 | 0.5 | 0.5 | 0.5 | | 0.5 | 0.5 |
| Dynasylan GLYEO | | | | | | | | 0.5 | | |
| Zircosol AC 20 | 0.6 | 0.6 | 0.6 | 0.6 | 0.6 | 0.6 | 0.6 | | 0.6 | 1.5 |
| Zirconium(IV) | | | | | | | | 0.6 | | |
| acetate | | | | | | | | | | |
| Vanadium(V) | | | | | | | | 0.2 | | |
| oxide; (99%) | | | | | | | | | | |
| Vanadium(3) | 0.2 | 0.2 | 0.2 | 0.2 | 0.2 | 0.2 | 0.2 | | 0.2 | 0.2 |
| acetylacetonate | | | | | | | | | | |
| Rutile R996 | 6 | 6 | 6 | 6 | 6 | 6 | 6 | | 6 | 6 |
| Pigment White 18 | | | | | | | | 6 | | |
| Solid total | 27.8 | 27.3 | 27.8 | 27.3 | 27.3 | 27.3 | 27.3 | 28.3 | 28.3 | 29.2 |
| Composition total | 100 | 100 | 100 | 100 | 100 | 100 | 100 | 100 | 100 | 100 |
| | | CE | CE | CE | CE | CE | CE | | | |
| | E15 | 14 | 15 | 16 | 17 | 18 | 19 | E16 | E17 | E18 |
| Leasys 5531 | | | | | | | | | | |
| Hauthane L-3528 | 17.5 | 17.5 | 17.5 | 17.5 | 17.5 | 17.5 | 17.5 | 17.5 | 17.5 | 17.5 |
| BS PUAW TT-10 | | | | | | | | | | |
| Bi-functional epoxy | 3.5 | 3.5 | 3.5 | 3.5 | 3.5 | 3.5 | | 3.5 | | 3.5 |
| resin precursor (C1) | | | | | | | | | | |
| Bi-functional epoxy | | | | | | | | | 3.5 | |
| resin precursor (C2) | | | | | | | | | | |
| MR1487W | | | | | | | | | | |
| JH-O1871 | | 0.1 | | | 0.5 | 0.5 | 0.5 | 0.5 | 0.5 | |
| Dynasylan GLYEO | 0.5 | | 0.1 | 0.5 | | | | | | 0.5 |
| Zircosol AC 20 | | 0.6 | | | 0.6 | 0.6 | 0.6 | 0.6 | 0.6 | |
| Zirconium(IV) | 1.5 | | 0.6 | 0.6 | | | | | | 0.6 |
| acetate | | | | | | | | | | |
| Vanadium(V) | 0.2 | | 0.2 | 0.2 | | | | | | 0.2 |
| oxide; (99%) | | | | | | | | | | |
| Vanadium(3) | | 0.2 | | | 0.2 | | 0.2 | 0.2 | 0.2 | |
| acetylacetonate | | | | | | | | | | |
| Rutile R996 | | 6 | | | 12 | 6 | | | | |
| Pigment White 18 | 6 | | 6 | 12 | | | | | | |
| Solid total | 29.2 | 27.9 | 27.9 | 34.3 | 34.3 | 28.1 | 18.8 | 22.3 | 22.3 | 22.3 |
| Composition total | 100 | 100 | 100 | 100 | 100 | 100 | 100 | 100 | 100 | 100 |

Table 5 shows the compositions of the examples E14 to E18 and comparative examples CE5-CE19.

TABLE 6

| | CE5 | CE6 | CE7 | CE8 | CE9 | CE10 | CE11 | CE12 | CE13 | E14 |
|---|---|---|---|---|---|---|---|---|---|---|
| Film thickness | 1.2~ | 1.2~ | 1.2~ | 1.2~ | 1.2~ | 1.2~ | 1.2~ | 1.2~ | 1.2~ | 1.2~ |
| (μm) | 1.7 | 1.7 | 1.7 | 1.7 | 1.7 | 1.7 | 1.7 | 1.7 | 1.7 | 1.7 |
| Cross Neutral | F | F | F | G | G | F | F | G | G | G |
| salt spray test | 3~4 | 3~4 | 3~4 | 1~2 | 1~2 | 3~4 | 3~4 | 2 mm | 1~2 | 1~2 |
| 240 hrs | mm | mm | mm | mm | mm | mm | mm | | mm | mm |
| Plate Neutral salt | VG | G | G | G | G | G | G | G | VG | VG |
| spray test 500 hrs | | | | | | | | | | |
| Scrap edge | G | G | P | G | G | G | G | VG | VG | VG |
| Neutral salt spray | 6 mm | 3~5 | 7~9 | 3~5 | 3~5 | 3~5 | 3~5 | 1~3 | 1-3 | 1~3 |
| test 240 hrs | | mm | mm | mm | mm | mm | mm | mm | mm | mm |
| T-bend test | 3 T | 3 T | 3 T | 2 T | 3 T | 3 T | 3 T | 2 T | 2 T | 0 T |
| (fresh) | | | | | | | | | | |
| T-bend test | 3 T | >4 T | 3 T | 3 T | 4 T | 4 T | 4 T | 3 T | 3 T | 1 T |
| (aged) | | | | | | | | | | |
| Cross-hatch and | F | F | F | F | F | F | F | F | G | G |
| cupping test | 5% | 30~ | 10% | 5~ | 10~ | 20~ | 30~ | 8% | <2% | 1~2% |
| | | 45% | | 10% | 15% | 25% | 45% | | | |
| Reverse Impact | G | F | G | F | F | F | F | F | P | G |
| Testing | | | | | | | | | | |
| MEK rub test | G | F | G | F | F | F | F | G | G | G |
| Alkali resistance | P | G | G | G | G | G | G | F | VG | P |
| Sulfuric acid | P | G | G | G | G | G | G | F | VG | P |
| resistance test | | | | | | | | | | |
| Hydrochloric | P | G | G | G | G | G | G | F | VG | P |
| acid resistance | | | | | | | | | | |
| test | | | | | | | | | | |
| Gloss | G | G | G | G | G | G | G | G | G | G |
| Color different | G | G | G | G | G | G | G | G | G | G |
| The topcoat | P ≥ | P | P ≥ | P ≥ | P ≥ | P ≥ | P | P ≥ | P ≥ | P ≥ |
| pencil hardness | HB | H | HB | HB | HB | HB | H | HB | HB | HB |
| | E15 | CE14 | CE15 | CE16 | CE17 | CE18 | CE19 | E16 | E17 | E18 |
| Film thickness | 1.2~ | 1.2~ | 1.2~ | 1.2~ | 1.2~ | 1.2~ | 1.2~ | 1.2~ | 1.2~ | 1.2- |
| (μm) | 1.7 | 1.7 | 1.7 | 1.7 | 1.7 | 1.7 | 1.4 | 1.4 | 1.4 | 1.4 |
| Cross Neutral | G | F | F | F | F | F | G | VG | G | VG |
| salt spray test | 2 mm | 3~4 | 4 mm | 4~5 | 4 mm | 5 mm | 1~2 | 0~1 | 1~2 | 0~1 |
| 240 hrs | | mm | | mm | | | mm | mm | mm | mm |
| Plate Neutral salt | VG | G | G | G | G | F | G | VG | VG | VG |
| spray test 500 hrs | | | | | | 7 mm | | | | |
| Scrap edge | G | G | G | P | P | P | P | VG | VG | VG |
| Neutral salt spray | 3~5 | 6 mm | 3~5 | 7~9 | 7~9 | 6~7 | 7~9 | 1~2 | 1~2 | 1~2 |
| test 240 hrs | mm | | mm | mm | mm | mm | mm | mm | mm | mm |
| T-bend test | 0 T | 0 T | 0 T | 1 T | 1 T | 0 T | 2 T | 0 T | 0 T | 0 T |
| (fresh) | | | | | | | | | | |
| T-bend test | 1 T | 1 T | 1 T | 2 T | 2 T | 0 T | 3 T | 0 T | 1 T | 0 T |
| (aged) | | | | | | | | | | |
| Cross-hatch and | G | VG | VG | F | F | VG | F | VG | VG | VG |
| cupping test | 1~2% | 0% | 0% | 5~7% | 5~7% | 0% | 10% | 0% | 0% | 0% |
| Reverse Impact | G | G | G | G | G | G | G | G | G | G |
| Testing | | | | | | | | | | |
| MEK rub test | G | G | P | F | F | G | G | G | G | G |
| Alkali resistance | P | G | P | F | P | VG | G | VG | F | VG |
| Sulfuric acid | P | G | F | F | P | VG | G | VG | G | VG |
| resistance test | | | | | | | | | | |
| Hydrochloric | P | G | F | F | P | VG | G | VG | G | VG |
| acid resistance | | | | | | | | | | |
| test | | | | | | | | | | |
| Gloss | G | G | G | F | F | G | F | F | F | F |
| | | | | ΔΕ > 3 | ΔΕ > 3 | | ΔΕ > 3 | ΔΕ > 3 | ΔΕ > 3 | ΔΕ > 3 |
| Color different | G | G | G | F | F | G | F | F | F | F |
| | | | | ΔΕ > 3 | ΔΕ > 3 | | ΔΕ > 3 | ΔΕ > 3 | ΔΕ > 3 | ΔΕ > 3 |
| The topcoat | P ≥ | P ≥ | P ≥ | P ≥ | P ≥ | P ≥ | P ≥ | P ≥ | P ≥ | P ≥ |
| pencil hardness | HB | HB | HB | HB | HB | HB | HB | HB | HB | HB |

Table 6 shows testing results of the examples E14 to E18 and comparative examples CE5-CE19.

1. A protection coating composition comprises:
a) at least one resin, the resin being selected from a group consisting of polyurethane resin (A), polyurethane-acrylic resin(B),
b) a solvent, and
c) a bi-functional epoxy resin precursor (C), the bi-functional epoxy resin precursor (C) being represented by the following formulas:
R₁—Y—[CH₂—CH(OH)—R₃—CH(OH)—CH₂—X—R₄—X]ₙ—R₂
wherein, independently,
X=—COO—, sulphur moiety, —NR(H)—, —P(OR)₂—O—, —P(OR)(OH)—O—, —PO—O—;
Y=—COO—, sulphur moiety, —NR(H)—, —P(OR)₂—O—, —P(OR)(OH)—O—, —PO—O—;
R₂ being aromatic chain or aliphatic chain having from 1 to 20 carbon atoms or H;
R₄ being aromatic chain or aliphatic chain having from 1 to 20 carbon atoms;
R₁ being aromatic chain or aliphatic chain having from 1 to 20 carbon atoms, —XH or —X—R₄;
R₃ being any types of chain as far as it connects two hydroxyl α-carbon atoms;
n being an integer of 1˜10
and
d) 1.5 to 5.0 wt. % of a metallic inhibitor, based on the total weight of solid contents in the composition, the metallic inhibitor comprising a zirconium compound selected from a group consisting of ammonium zirconium carbonate, potassium zirconium carbonate, basic zirconium carbonate, zirconium acetate, and combination.

2. The protection coating composition according to claim 1, wherein, independently, R₂ being aromatic chain or aliphatic chain having from 1 to 10 carbon atoms or H, R₄ being aromatic chain or aliphatic chain having from 1 to 10 carbon atoms, R₁ being aromatic chain or aliphatic chain having from 1 to 10 carbon atoms, —XH or —X—R₄.

3. The protection coating composition according to claim 1, wherein R₃ being selected from the group consisting of aromatic or aliphatic moiety having from 1 to 20 carbon atoms, polyurethane moiety, aliphatic or aromatic alkane having from 2 to 20 carbon atoms, acrylates containing polymer moiety.

4. The protection coating composition according to claim 1, wherein X being selected from —COO—, —P(OR)(OH)—O—; and n being an integer of 2˜8.

5. The protection coating composition according to claim 1, wherein, the bi-functional epoxy resin precursor (C) being represented by the following formulas:
(H)X—R₄—X—[CH₂—CH(OH)—R₃—CH(OH)—CH₂—X—R₄—X]ₙ—H
wherein, independently,
X=—COO—, —P(OR)(OH)—O—;
R₄ being aromatic chain or aliphatic chain having from 1 to 10 carbon atoms;
R₃ being any types of chain as far as it connects two hydroxyl α-carbon atoms;
n being an integer of 2˜8.

6. The protection coating composition according to claim 1, wherein components c) are present in 4.5 wt. % to 35 wt. %, based on the total weight of the solid contents in the protection coating composition.

7. The protection coating composition according to claim 1, wherein the content ratio of the bi-functional epoxy resin precursor (C) to the total mass of polyurethane-acrylic resin (B), polyurethane resin (A), polyacrylic-epoxy resin (D) and bi-functional epoxy resin precursor (C) is from 7.0 wt. % to 30 wt. %.

8. The protection coating composition according to claim 1, wherein the protection coating composition further comprises a polyacrylic-epoxy resin (D).

9. The protection coating composition according to claim 1, wherein the protection coating composition further comprises 1.0 wt. % to 4.5 wt. % of a silanol group containing resin, based on the total weight of solid contents, the silanol group containing resin being represented by the following formulas XY(Z)ₙSi(OH)₃₋ₙ, wherein, independently, X being a glycidoxy group or functional group derived from a glycidoxy group, Y being a C1 to C10 alkylene group, Z being a methoxy group, ethoxy group or methyl group, and n being an integer of 0 to 2.

10. The protection coating composition according to claim 1, wherein the protection coating composition further comprises 0.1 to 3 wt. % of a wax, based on the total weight of the protection coating composition.

11. The protection coating composition according to claim 1, wherein the protection coating composition further comprises 1 to 20 wt. % of a filler, based on the total weight of the solid contents in the composition.

12. (canceled)

13. (canceled)

14. The protection coating composition according to claim 1, wherein the pH value of the protection coating composition is from equal to or greater than 8 to 10.

15. (canceled)

16. The protection coating composition according to claim 1, wherein the solid content of the protection coating composition is 25 wt. % to 35 wt. %, based on the total weight of the protection coating composition.

17. A method for providing anticorrosion protection and enhanced coating adhesion on a metallic surface, comprising steps of:
a) bringing the protection coating composition according to claim 1 into contact with a metallic surface at a process temperature of at least 40° C., but no higher than 200° C., thereby creating a film on the metallic surface;
b) optionally removing excess quantities of the protection coating composition from the surface; and
c) curing the film located on the surface by means of thermal methods at a process temperature of 50-90° C., or high-energy irradiation for a period of at least 10-5 seconds to form a cured coating.

18. The method according to claim 17, wherein the cured coating exhibits a layer thickness of at least 0.5 μm, but of no more than 4.0 μm.

19. An article having at least one portion that comprises the treated metallic surface of claim 17.

20. The article of claim 19, wherein protection coating exhibits a layer thickness of at least 0.5 μm, but of no more than 4.0 μm.

21. The article of claim 20, said treated metallic surface has a T-bend (fresh) of equal to or less than 1 T when subjected to GB/T13448-2006, a T-bend (aged, after 24 hours aging at a temperature of 50±2° C. and a humidity of 95%) of equal to or less than 2 T when subject to GB/T13448-2006.

22. An article having at least one portion that comprises a protection coating, wherein the protection coating is a cured product of the protection coating composition according to claim 1.

23. The article according to claim 22, wherein the protection coating exhibits a layer thickness of at least 0.5 μm, but of no more than 4.0 μm.
